(19) United States
(12) Patent Application Publication
(10) Pub. No.: US 2006/0150167 A1
(43) Pub. Date: Jul. 6, 2006

(54) System and method for integrating non-native storage devices in an information handling system image

(76) Inventors: Jeremy R. Ziegler, Pflugerville, TX (US); Samuel B. Henderson, Austin, TX (US)

Correspondence Address: HAMILTON & TERRILE, LLP, P.O. BOX 203518, AUSTIN, TX, 78720, US

(21) Appl. No.: 11/018,733

(22) Filed: Dec. 21, 2004

(51) Int. Cl. G06F 9/45

(52) U.S. Cl. 717/143; 719/321

(57) ABSTRACT

Non-native drivers are pre-integrated into the operating system of an image for a manufactured information handling system to allow the operating system to support the device associated with the non-native driver on initial boot of the manufactured information handling system. For instance, registry and critical device database information is parsed from a non-native hard disc drive controller driver and copied into the operating system of a manufactured information handling system so that the operating system will recognize the hard disc drive controller on initial boot to allow the operating system to be retrieved from the hard disc drive. Additionally, the non-native drive operating system information is copied to a source copy of the operating system on the hard disc drive for use in recovery of the operating system at the information handling system.

### BACKGROUND OF THE INVENTION

1. Field of the Invention

The present invention relates in general to the field of information handling system manufacture, and more particularly to a system and method for integrating non-native storage devices in an information handling system image.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are typically manufactured to include an operating system and applications desired by the end user. Generally, information handling system manufacturers include the operating system and applications by creating a hard disc drive image created to have a configuration as if installed on a manufactured information handling system. Once the physical components of the information handling system are assembled, the system is powered under a manufacturing operating system and the image is copied to the hard disc drive of the system. When the information handling system is next booted, the operating system from the image of the hard disc drive is used to control the information handling system for final testing. Copying of an image to a hard disc drive saves considerable time in the manufacturing process when compared with the time typically required to individually install an operating system and applications and also allows mass production of similarly configured systems by copying a common image to multiple systems.

One difficulty that arises with the use of images in the manufacture of information handling systems is that a manufacturing image will not include device drivers for operating system controlled devices that are not native to the operating system. In particular WINDOWS NT based operating systems, such as WINDOWS XP, must have all supported SCSI devices defined and have drivers in the image in order for the operating system to boot from the image. If a hard disc controller of a manufactured information handling system does not have its driver included native to the operating system, then the initial attempt to boot from the hard disc drive image will fail because the operating system has no knowledge of how to access device supported by the hard disc drive controller. Instead, the operating system will issue a blue screen error stating IN ACCESSIBLE_BOOT_DEVICE. When this occurs, the image generally must be rebuilt to include the hard disc drive non-native controller. Rebuilding an image from scratch increases test and development time and reduces the velocity at which new SCSI devices are implemented into the factory install process. As an alternative, a technician may manually install the drivers using current operating system hooks, however, manual intervention requires some technician expertise, invites human error and takes time to accomplish. Further, manual installation must generally be performed twice, one for the primary operating system and again for the source operating system used to recover the information handling system in the event of primary operating system failure.

### SUMMARY OF THE INVENTION

Therefore a need has arisen for a system and method which automates the integration of non-native hard disc drive devices into an information handling system manufacturing image.

In accordance with the present invention, a system and method are provided which substantially reduce the disadvantages and problems associated with previous methods and systems for updating an information handling system manufacturing image with non-native device drivers. Non-native components of an information handling system are identified during manufacture in order to automatically update the operating system of the manufacturing image to include non-native driver support at initial boot of the information handling system.

More specifically, a manufacturing server has an image engine that loads an image to a manufactured information handling system, the image having a primary operating system that supports native processing components with native drivers. A driver engine loads non-native drivers onto the information handling system to support operation of processing components that are non-native to the information handling system. A parser parses the non-native drivers to identify operating system information that the operating system uses to operate the non-native components, such as the registry and critical device database entries loaded during an install of the driver to the operating system. The parser copies the non-native component operating system to the image of the manufactured information handling system so that the operating system recognizes the non-native component on an initial boot without having to perform an install of the non-native driver. A recovery engine applies the non-native driver operating system information to a source recovery operating system to ensure that the manufactured information handling system has a recovery operating system that will boot in the event of failure of the primary operating system.

The present invention provides a number of important technical advantages. One example of an important technical advantage is that a manufactured information handling system will recognize non-native processing components on an initial boot without requiring a separate install of the driver. Where the non-native component is the hard disc drive controller driver, pre-integration of non-native drivers ensures that the operating system will recognize the hard disc drive on initial boot rather than fail the initial boot, thus avoiding disruption of the manufacturing process and the delays associated with re-configuring an image to include the non-native driver or manually configuring the non-native driver. Further, pre-integration of the non-native driver with the recovery operating system helps to ensure that the recovery operating system will boot properly in the event of failure of the primary operating system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for pre-integration of non-native component drivers into an operating system on an image of a manufactured information handling system;

FIG. 2 depicts a process for pre-integration of non-native component drivers into an operating system on an image of a manufactured information handling system; and

FIG. 3 depicts a process for pre-integration of non-native component drivers into an operating system recovery source of a manufactured information handling system.

### DETAILED DESCRIPTION

Pre-integration of non-native component drivers into an operating system on an image of a manufactured information handling system reduces delays in the manufacture of the information handling system by enabling initial boot of the operating system on the manufactured information handling system from the non-native component. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

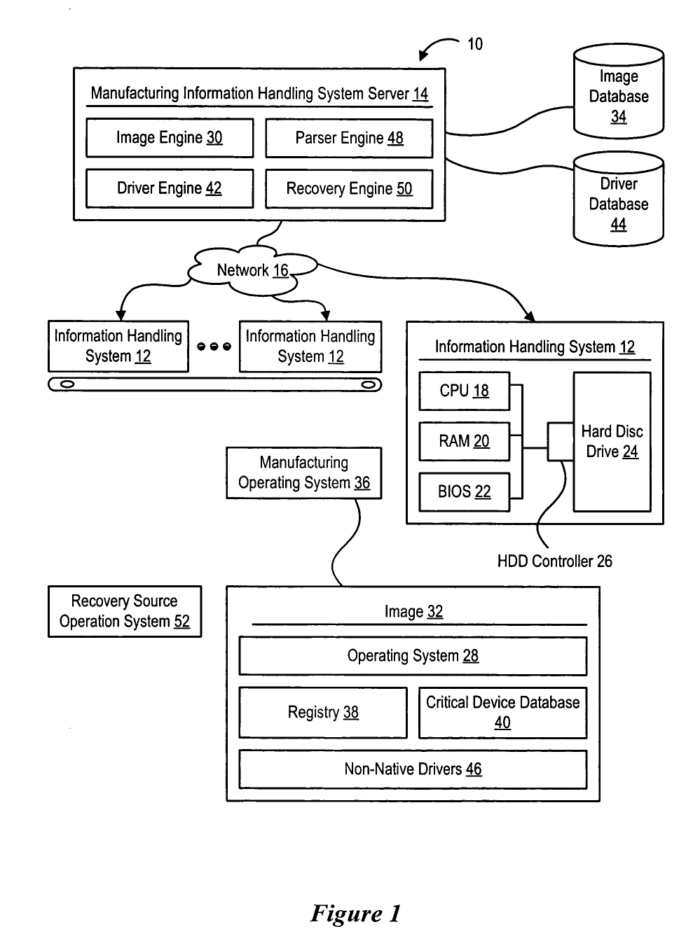

Referring now to FIG. 1, a block diagram depicts a system 10 for pre-integration of non-native component drivers into an operating system on an image of manufactured information handling systems 12. A manufacturing information handling system server 14 manages image loading and configuration on information handling systems 12 through a network 16. Manufactured information handling systems 12 include assembled processing components, such as a CPU 18, RAM 20, BIOS 22 and a hard disc driver 24 managed by a hard disc drive controller 26, that are configured to run applications under the control of an operating system 28. An image engine 30 copies a desired image 32 from an image database 34 onto a mass storage device of each manufactured information handling system 12, such as hard disc drive 24. Image engine 30 communicates to manufactured information handling system 12 through a manufacturing operating system 36, such as a DOS or Linux kernel loaded in a PXE environment. Once operating system 28 is loaded as part of image 32, information handling system 12 may be booted to operating system 28 as long as the processing components on information handling system 12 are native to operating system 28 and thus found by reference to a registry 38 and a critical device database 40. If the mass storage device that holds operating system 28 is a non-native component, i.e., not found in registry 38 and critical device database 40, then the boot will fail since the operating system will fail to recognize the mass storage device.

In order to ensure that non-native components will be supported by operating system 28, a driver engine 42 compares the components of manufactured information handling system 12 with a driver database 44 and copies non-native drivers 46 to image 28. Once the non-native drivers are identified, a parser engine 48 parses the drivers to determine operating system information that operating system 28 will need to use the non-native drivers. By automatically identifying the operating system information associated with each non-native driver, parser engine 48 prepares operating system 28 to run the components with the non-native drivers without technician intervention or running an install process with the operating system. Parser engine 48 seeks to identify the files used by the operating system to install the driver with a native installation process and then applies the identified files from outside the operating system by inserting them as appropriate in image 28, such as in registry 38 and critical device database 40. Once parser engine has identified and inserted the non-native driver information to support operation of the non-native components, a recovery engine 50 applies the non-native driver information to a recovery source operating system 52 to make the non-native drivers appear native to the source operating system so that a recovery to operating system 52 will boot with the non-native components.

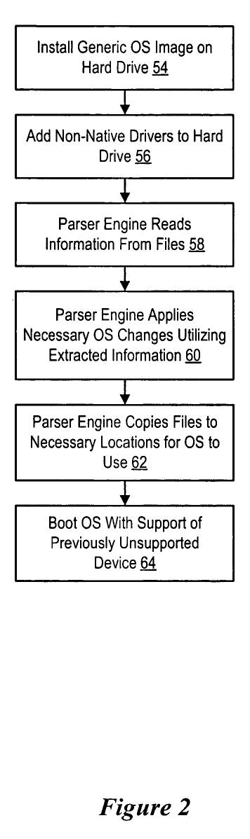

Referring now to FIG. 2, a flow diagram depicts a process for pre-integration of non-native component drivers into an operating system on an image of a manufactured information handling system. The process begins at step 54 with installation of a generic operating system image on the manufactured information handling system hard disc drive. The generic operating system includes drivers for native devices that are supported by the operating system. At step 56, non-native drivers that are not included in the generic operating system are copied to the hard disc drive. At step 58, the parser engine reads information from the driver files so that, at step 60, the information necessary to support recognition by the operating system of the non-native components is applied to the operating system, such as the registry and critical device database information associated with a normal install of the non-native driver. At step 62, the parser engine copies the identified non-native driver information to the necessary locations of the operating system, such as the registry and critical device database. At step 64, the operating system boots with support from the previously unsupported non-native devices to allow the manufacture process to continue.

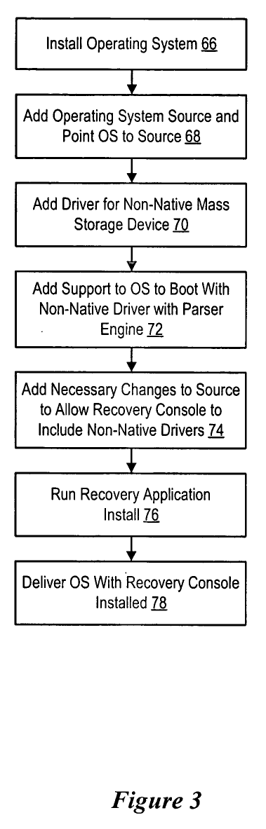

Referring now to FIG. 3, a flow diagram depicts a process for pre-integration of non-native component drivers into an operating system recovery source of a manufactured information handling system. The process begins as before with the installation of the operating system image at step 66 and continues to step 68 at which the operating system source is added to the image and the primary operating system is pointed to the source for recovery purposes. At step 70, the non-native drivers are added as before, such as the driver for the non-native mass storage device that stores the image and operating system source, and at step 72, the non-native driver information is added to the operating system to support boot by the operating system with non-native devices. In order to bring the recovery source operating system in line with the primary operating system and to ensure that the recovery source operating system will boot to non-native devices, at step 74 the changes made to the primary operating system to support non-native drivers are also made to the recovery source operating system. At step 76 a recovery application installation is run to prepare the information handling system to recover, if necessary, from the recovery source operating system and at step 78 the operating system installation is completed with the recovery operating system installed.

Although the present invention has been described in detail, it should be understood that various changes, substitutions and alterations can be made hereto without departing from the spirit and scope of the invention as defined by the appended claims.

What is claimed is:

1. A system for manufacture of an information handling system having a mass storage device and an operating system, the system comprising:
an image engine operable to interface with the information handling system and to copy an image to the mass storage device, the image having the operating system;
a driver engine operable to interface with the information handling system and to copy non-native drivers to the mass storage device; and
a driver parser operable to interface with the information handling system, to automatically parse the non-native drivers for determining operating system entries associated with the non-native drivers, and to copy the operating system entries to the operating system of the image.

2. The system of claim 1 wherein the operating system entries comprise registry entries and critical device database entries.

3. The system of claim 2 wherein the non-native drivers comprise drivers for the mass storage device, the mass storage device drivers enabling recognition of the mass storage device by the operating system to support boot of the information handling system from the mass storage device.

4. The system of claim 3 wherein the mass storage device is a hard disc drive controller.

5. The system of claim 1 further comprising a manufacturing operating system operable to run the information handling system and wherein the image engine, driver engine and driver parser interface with the information handling system through a network connection supported by the manufacturing operating system.

6. The system of claim 1 further comprising a recovery engine operable to interface with the information handling system and the driver parser, the recovery engine further operable to create an operating system source file having the parsed non-native driver entries and to copy the source file to the mass storage device as recovery resource in the event of operating system failure at the information handling system.

7. The system of claim 6 wherein the operating system entries comprise registry entries and critical device database entries.

8. A method for manufacture of an information handling system, the method comprising:
copying an image to a mass storage device of the information handling system, the image having an operating system;
copying one or more non-native drivers to the operating system;
automatically parsing the non-native drivers on the information handling system to determine operating system entries associated with the non-native drivers;
automatically copying the determined operating system entries to the operating system; and
booting the information handling system from the operating system, the booting relying at least in part on the non-native drivers.

9. The method of claim 8 wherein the operating system entries comprise registries entries and critical device database entries.

10. The method of claim 9 wherein the non-native drivers comprise a driver for the mass storage device.

11. The method of claim 10 wherein the mass storage device is a hard disc drive controller.

12. The method of claim 11 wherein booting the information handling system further comprises booting the information handling system by recognizing the hard disc drive controller with the non-native drivers.

13. The method of claim 8 further comprising:
copying the operating system to the mass storage device as a recovery source file; and
copying the determined operating system entries to the recovery source file.

14. The method of claim 13 further comprising:
reading the recovery source file to recover the operating system; and
booting the information handling system from the recovery source file by recognizing the mass storage device with the determined operating system entries.

15. The method of claim 14 wherein the determined operating system entries comprise registry entries and critical device database entries.

16. An information handling system comprising:
an image engine operable to copy an image to a manufactured information handling system, the image having an operating system, the operating system having drivers to support communication with processing components of the information handling system;
a driver engine operable to copy one or more drivers to the manufactured information handling system, the drivers non-native to the operating system; and
a parser engine operable to parse a non-native driver to determine operating system entries associated with the driver and to copy the operating system entries to the operating system, the operating system entries enabling the operating system to recognize a component associated with the driver to boot from the component.

17. The information handling system of claim 16 wherein the component associated with the driver comprises a hard disc drive controller.

18. The information handling system of claim 17 wherein the operating system entries comprise registry and critical device database information.

19. The information handling system of claim 18 further comprising a recovery engine operable to copy the operating system on the manufactured information handling system as a source reference, the recovery engine further operable to copy the registry and critical device database information to the operating system source reference.

20. The information handling system of claim 19 wherein the image engine, driver engine, parser engine and recovery engine communicate with the manufactured information handling system through a network connection.
